(19) United States
(12) Patent Application Publication
(10) Pub. No.: US 2002/0105437 A1
(43) Pub. Date: Aug. 8, 2002

(54) Multi-technology, short-range/long-range repeater for telemetry control of mechanized irrigation equipment

(76) Inventors: Ron Pollak, Elkhorn, NE (US); Bruce Kreikemeier, West Point, NE (US); Marv Schulz, Omaha, NE (US); Craig Malsam, Omaha, NE (US); Charlie Medinger, Lincoln, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 09/778,504

(22) Filed: Feb. 7, 2001

(51) Int. Cl. G05D 7/00

(52) U.S. Cl. 340/870.28; 700/284

(57) ABSTRACT

A multi-technology repeater collects a long-range signal from a wireless communication device and re-transmits the signal to one or more of the irrigation components of a mechanized irrigation system. The repeater receives the long-range signal and re-transmits the signal using short-range spread spectrum to the devices in the field. The repeater may also act as a long-range repeater and would re-transmit the signal using VHF to another long-range destination device.

### BACKGROUND OF THE INVENTION

1. Field of the Invention

This invention relates to a multi-technology, short-range/long-range repeater for telemetry control of mechanized irrigation equipment. More particularly, the multi-technology repeater is used in the field to be irrigated to convert long-range technology into short-range technology for all in-field adjacent equipment.

2. Description of the Related Art

Mechanized irrigation equipment, such as a center pivot irrigation system, sometimes include telemetry controls which are mounted on the pivot for controlling components of the system. Because the system moves in a circle around the pivot, the height of the antenna for the telemetry equipment is limited to being positioned just below the span to provide the necessary clearance. The positioning of the antenna of the telemetry equipment to being just below the span significantly reduces the range and performance of the telemetry. One possible solution to the problem described above is to mount the antenna to the top of the span and sending the signal received by the antenna through the existing electrical connection at the swivel, known as the collector ring. This is an undesirable solution due to the noise and signal loss resulting from the signal passing through the collector ring.

Another disadvantage of the conventional telemetry controlled systems is that most equipment under telemetry control is near or adjacent to each other. In other words, all the equipment is in or near the field under control. However, the remote operator could be many miles away. The existing methods use single long-range technology, which is expensive and limits telemetry options.

### SUMMARY OF THE INVENTION

A multi-technology, short-range/long-range repeater is provided for telemetry control of mechanized irrigation equipment such as a center pivot irrigation system. The mechanized irrigation system includes irrigation components or equipment for irrigating a field. The multi-technology repeater is located on or near the irrigation system and collects a signal from a wireless communication device which re-transmits the signal to one or more of the irrigation components in the field through remote links. The repeater is mounted on the highest point in the field or the span of the irrigation system. The repeater converts the long-range technology into short-range technology for all in-field components to be controlled. The repeater can collect long-range inputs from RF devices such as VHF, UHF, spread spectrum radio, cell phone, etc., or optical telemetry, and converts it to the short-range telemetry technology of the destination device.

It is a principal object of the invention to provide an improved method and means for the telemetry control of mechanized irrigation equipment.

A further object of the invention is to provide a method and means including a multi-technology repeater which receives long-range signals and which converts those signals into short-range signals which are transmitted to remote links which control the various components of the system.

A further object of the invention is to provide a method and means of the type described above which eliminates the shortcomings of the prior art.

Still another object of the invention is to provide a repeater of the type described above which may be placed anywhere in the field, including on the highest point of the mechanized irrigation equipment.

Still another object of the invention is to provide a method and means of the type described above which eliminates signal-loss issues resulting from collector rings.

Still another object of the invention is to provide a multi-technology, short-range/long-range repeater for telemetry control of mechanized irrigation equipment which eliminates antenna height restrictions due to the physical characteristics of the mechanized equipment.

Yet another object of the invention is to provide a multi-technology, short-range/long-range repeater for telemetry control of mechanized irrigation equipment which is wireless.

Still another object of the invention is to provide a repeater of the type described above which is based on multi-technology telemetry, thereby eliminating incompatibility issues.

These and other objects will be apparent to those skilled in the art.

### BRIEF DESCRIPTION OF THE DRAWINGS

FIG. 1 is a perspective view of a conventional mechanized irrigation system; and

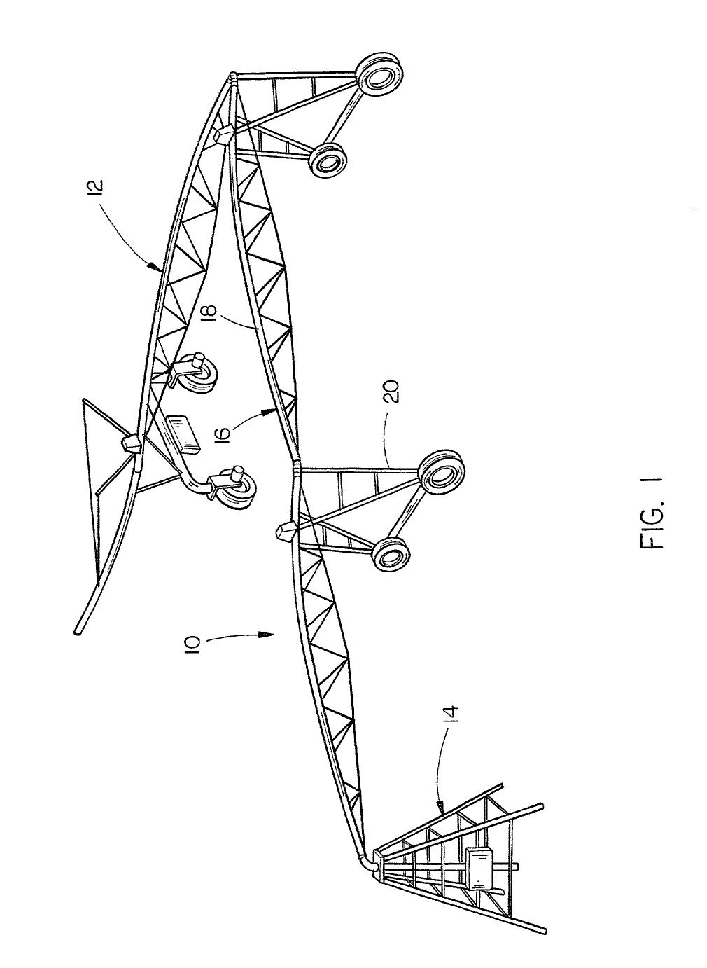

FIG. 2 is a schematic which illustrates the method and means of this invention.

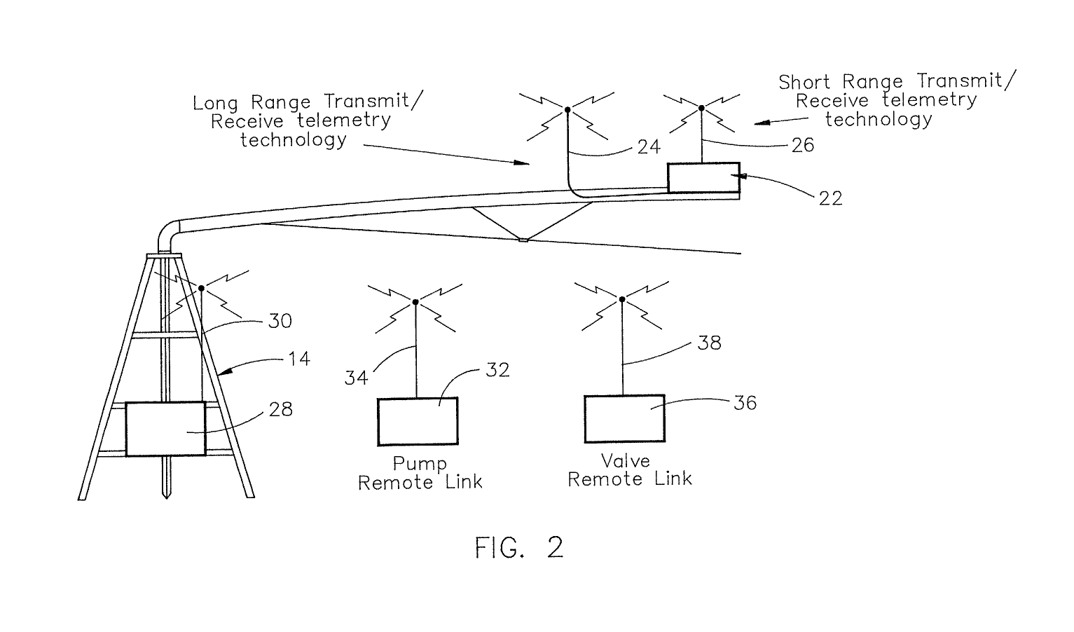

### DESCRIPTION OF THE PREFERRED EMBODIMENT

The numeral 10 refers to a mechanized irrigation system which, in this case, is a center pivot system having a corner irrigation system 12 at the outer end thereof. System 10 includes a stationary pivot 14 about which the system pivots in the field to irrigate the field. System 10 includes a span generally indicated at 16 for supporting the water line 18 which extends outwardly from the pivot 14 and which is supported upon a plurality of drive towers 20.

The numeral 22 refers to a wireless multi-technology, short-range/long-range repeater for telemetry control of the mechanized irrigation equipment. The repeater 22 is based on multi-technology telemetry to eliminate incompatibility issues. Components with cell phone, spread spectrum, VHF, etc., exist in the control system of the repeater and control signals are routed to appropriate destinations with the repeater 22. For purposes of description, repeater 22 will be described as including long-range transmit/receive telemetry technology 24 and short-range transmit/receive telemetry technology 26. The repeater 22 is preferably mounted on the span 16 for movement therewith about the pivot 14. By mounting the repeater 22 on the span, there are no antenna height restrictions due to the physical characteristics of the mechanized equipment. It should be noted that the repeater could be placed anywhere in the field, if so desired. If the repeater is located in the field, it is recommended that it be located at the highest point in the field.

The numeral 28 refers to telemetry controls which are mounted on the pivot 14 while the numeral 30 refers to an antenna for the controls 28. Remote links are also provided for controlling various components of the system. The numeral 32 refers to a pump remote link having an antenna 34 while the numeral 36 refers to a valve remote link having an antenna 38. Other remote links could also be used for controlling various components of the system.

The multi-technology repeater 22 converts the long-range technology into short-range technology for all in-field adjacent equipment. The repeater can collect long-range inputs from RF devices such as VHF, UHF, spread spectrum radio, cell phone, etc., or optical telemetry. Based on the destination, the repeater 22 transmits the message (repeats) to the destination device using the telemetry technology at the destination device. For example, the telemetry technology for long-range may be VHF radio. However, all devices in the field may be short-range spread spectrum. As stated, the multi-technology repeater 22 receives the long-range signal and then re-transmits the signal using short-range spread spectrum to the devices in the field. The same multi-technology repeater may also act as a long-range repeater and re-transmit the signal using VHF to another long-range destination device.

There are many advantages to the method and means described above. The repeater 22 can be placed anywhere in the field, including on the highest point of the mechanized irrigation equipment which aids the repeater in receiving the long-range signal. Since there is no hard-wired connection to the destination device, there are no signal loss issues resulting from collector rings. Also, there are no antenna height restrictions due to the physical characteristics of the mechanized equipment. Since the repeater 22 is wireless, there are no installation issues resulting from burying hard-wired connections. Since the repeater is based on multi-technology telemetry, there are no incompatibility issues. Components with cell phone, spread spectrum, VHF, etc., exist in the control system and control signals are routed to appropriate destinations with the multi-technology repeater.

Thus it can be seen that the invention accomplishes at least all of its stated objectives.

We claim:

1. In combination:
a mechanized irrigation system including irrigation components for irrigating a field;
a multi-technology repeater which collects a long-range signal from a wireless communication device and which re-transmits the signal to one or more of the irrigation components in the field.

2. The combination of claim 1 wherein said repeater is mounted on the irrigation system for movement therewith.

3. The combination of claim 2 wherein said irrigation system includes a span and wherein said repeater is mounted on said span.

4. The combination of claim 2 wherein said repeater is mounted on the highest point of said irrigation system.

5. The combination of claim 1 wherein said repeater re-transmits the signal to said irrigation component or components by wireless communication technology.

6. The combination of claim 1 wherein said irrigation system includes a pivot and telemetry controls mounted thereon; said telemetry controls being connected to said one or more irrigation components by wireless communication technology.

7. The combination of claim 1 wherein said repeater also has long-range re-transmitting capabilities for re-transmitting the collected signal to another long-range destination device.

8. The combination of claim 7 wherein said repeater re-transmits the signal to the long-range destination device by VHF.

9. The combination of claim 1 wherein each of said one or more irrigation components includes a remote link which receives the re-transmitted signal from said repeater and controls the associated component in response thereto.

10. The combination of claim 1 wherein said repeater includes long-range transmit/receive telemetry technology.

11. The combination of claim 1 wherein said repeater includes short-range transmit/receive technology.

12. The combination of claim 10 wherein said repeater includes short-range transmit/receive technology.

13. The method of telemetrically controlling one or more components of a mechanized irrigation system, comprising the steps of:
providing a multi-technology repeater;
transmitting a long-range telemetry signal to the repeater;
and re-transmitting the telemetry signal received by the repeater to the component or components of the irrigation system for controlling the operation thereof.

14. The method of claim 13 wherein a remote link is associated with each of the irrigation components to be controlled and wherein the repeater re-transmits the signal to the remote link for controlling the operation of the associated irrigation component.

15. The method of claim 14 wherein the signal is re-transmitted from the repeater to the remote link by wireless technology.

16. The method of claim 14 wherein each of the remote links are provided with short-range/transmit technology.

17. The method of claim 14 wherein said repeater re-transmits the signal to the remote link or links by short-range telemetry.

18. The method of claim 13 wherein said repeater functions as a short-range repeater.

19. The method of claim 13 wherein said repeater functions as a long-range repeater.
